(19) United States
(12) Patent Application Publication
(10) Pub. No.: US 2014/0173005 A1
(43) Pub. Date: Jun. 19, 2014

(54) ELECTRONIC DEVICE AND METHOD FOR QUICKLY SENDING EMAIL THEREOF

(71) Applicants: HON HAI PRECISION INDUSTRY CO., LTD., New Taipei (TW); HONG FU JIN PRECISION INDUSTRY (ShenZhen) CO., LTD, Shenzhen (CN)

(72) Inventors: HAI-SEN LIANG, Shenzhen (CN); CHIH-SAN CHIANG, New Taipei (TW); TE-JIA LIU, Shenzhen (CN); HAI-JUN MAO, Shenzhen (CN); HUA-DONG CHENG, Shenzhen (CN); LING-JUAN JIANG, Shenzhen (CN)

(73) Assignees: HON HAI PRECISION INDUSTRY CO., LTD., New Taipei (TW); HONG FU JIN PRECISION INDUSTRY (ShenZhen) CO., LTD, Shenzhen (CN)

(21) Appl. No.: 14/105,188

(22) Filed: Dec. 13, 2013

(30) Foreign Application Priority Data
Dec. 13, 2012 (CN) 2012105367499

(51) Int. Cl. H04L 12/58; G06F 3/0488

(52) U.S. Cl. CPC H04L 51/00; G06F 3/0488
USPC 709/206

(57) ABSTRACT

An exemplary method for quickly sending an email includes, firstly, generating operation signals in response to a shape drawn on a touch screen of an electronic device by a user. Next, the shape is identified, according to the received operation signals. Then one or more recipients' email addresses associated with the predefined shape are acquired when it is determined that the identified shape is similar to one of predefined shapes. Lastly, an email is sent to the acquired recipients' email addresses. An electronic device implementing the method is also provided.

### BACKGROUND

1. Technical Field

The present disclosure relates to an electronic device and a method for quickly sending an email using the electronic device.

2. Description of Related Art

To send an email, a user must open an email page, write an email in the opened page, and input at least one email address to send the email to. However, it is inconvenient and time-consuming to input the email address, especially if there are multiple email addresses to input.

Therefore, what is needed is an electronic device and a method to alleviate the limitations described above.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts or sections throughout the views.

FIG. 1 is a block diagram of an embodiment of an electronic device.

FIG. 2 is a schematic diagram of an embodiment of an editing interface of an email displayed on the electronic device of FIG. 1.

FIG. 3 is a schematic diagram of an embodiment of an input area displayed on the editing interface of the electronic device of FIG. 2.

FIG. 4 is a flowchart of an embodiment of a method for quickly sending an email using the electronic device of FIG. 1.

### DETAILED DESCRIPTION

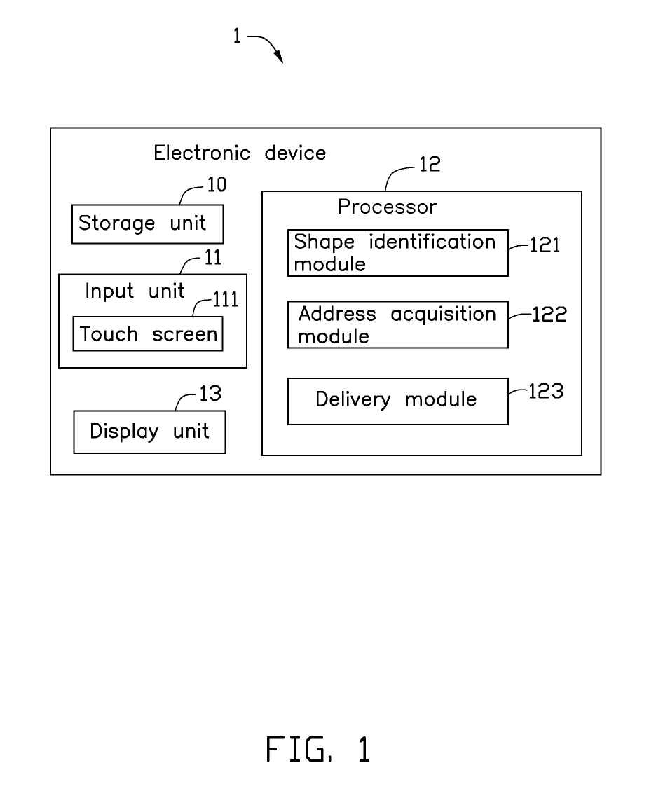

FIG. 1 shows an embodiment of an electronic device 1. The electronic device 1 comprises an input unit 11. In the embodiment, the electronic device 1 can send an email to a certain email address (or a certain number of email addresses) associated with a touch operation identified by the input unit 11. The electronic device 1 is a terminal device having a touch screen and/or a touchpad, such as a personal computer, a mobile phone, or a tablet computer.

The input unit 11 is configured for generating corresponding operation signals in response to touch operations performed thereon. The input unit 11 can be a touch screen, a touchpad, and/or any other component(s) or device(s) that can identify a touch operation, including a shape represented by a touch operation. In the embodiment, the input unit 11 comprises a touch screen 111.

The electronic device 1 also comprises a storage unit 10, a processor 12, and a display unit 13. The storage unit 10 stores a number of predefined shapes, a number of recipients' email addresses, and a mapping table recording a relationship between the predefined shapes and the recipients' email addresses. In the mapping table, each predefined shape corresponds to a recipient's email address or a number of recipients' email addresses. The mapping table can be predefined by a system of the electronic device 1 or by a user of the electronic device 1.

The processor 12 comprises a shape identification module 121, an address acquisition module 122, and a delivery module 123. The touch screen 111 overlies the display unit 13.

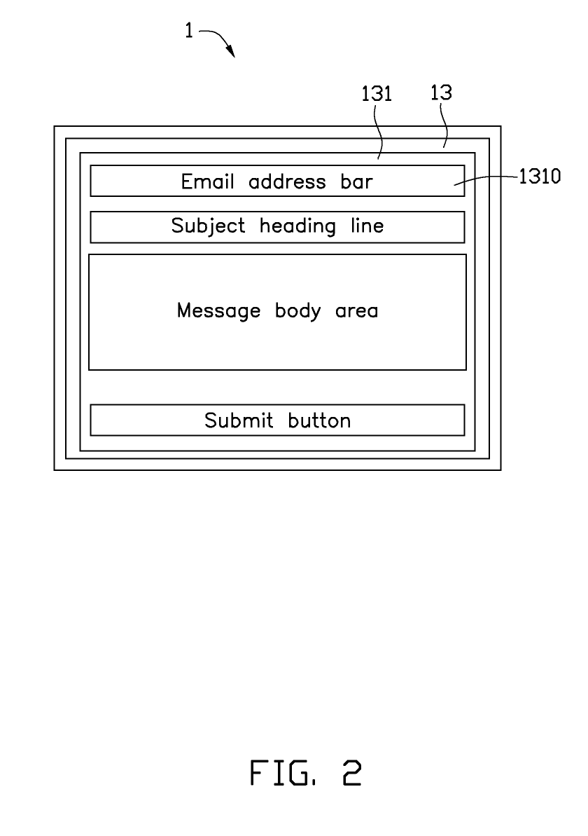

Referring also to FIG. 2, when the electronic device 1 is activated, the display unit 13 displays an email page 131 in response to touch operations performed on the input unit 11. The email page 131 initially displayed comprises an email address bar 1310, a subject heading line, a message body area, and a submit button. The email address bar 1310 relates to one or more intended recipients of an email to be sent by the user.

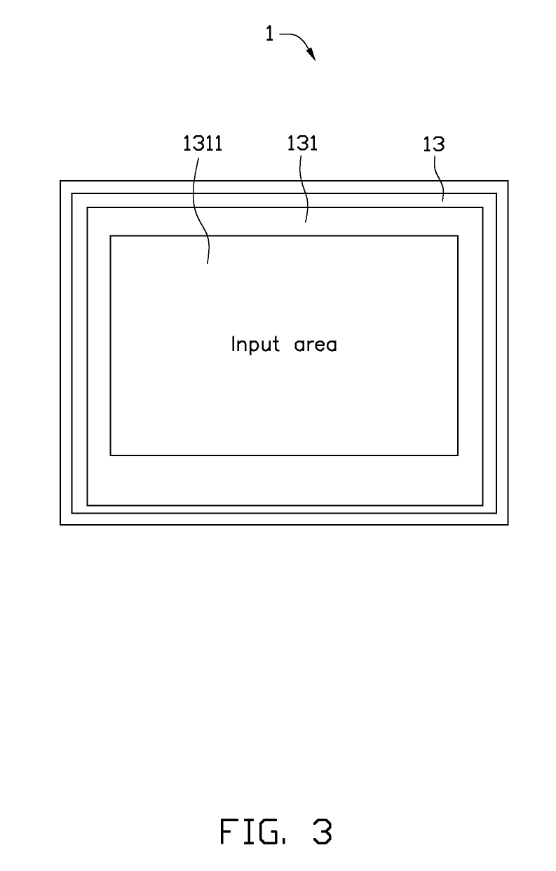

FIG. 3 shows that upon certain input by a user to the email page 131, the email page 131 comprises an input area 1311. In particular, the input area 1311 is displayed (or opened) in response to touch operations applied on the email address bar 1310 of the email page 131. The input area 1311 is displayed for the user to draw a shape corresponding to a recipient's email address. The touch screen 111 is further configured for generating corresponding operation signals in response to operations applied on the input area 1311. In the illustrated embodiment, a default size of the input area 1311 is smaller than a size of the email page 131. In an alternative embodiment, the default size of the input area 1311 is the same as the size of the email page 131.

The shape identification module 121 is configured for identifying a shape drawn by the user according to the operation signals generated by the touch screen 111. The shape identification module 121 is further configured for determining whether the identified shape is similar to a predefined shape stored in the storage unit 10. If the identified shape is similar to the predefined shape, the shape identification module 121 transmits the predefined shape to the address acquisition module 122.

The address acquisition module 122 is configured for acquiring one or more recipients' email addresses associated with the predefined shape when the shape identification module 121 determines that the identified shape is similar to the predefined shape stored in the storage unit 10.

The address acquisition module 122 further controls the display unit 13 to display the acquired one or more recipients' email addresses in the email address bar 1310 of the email page 131.

The delivery module 123 is configured for sending an email to the acquired one or more recipients' email addresses.

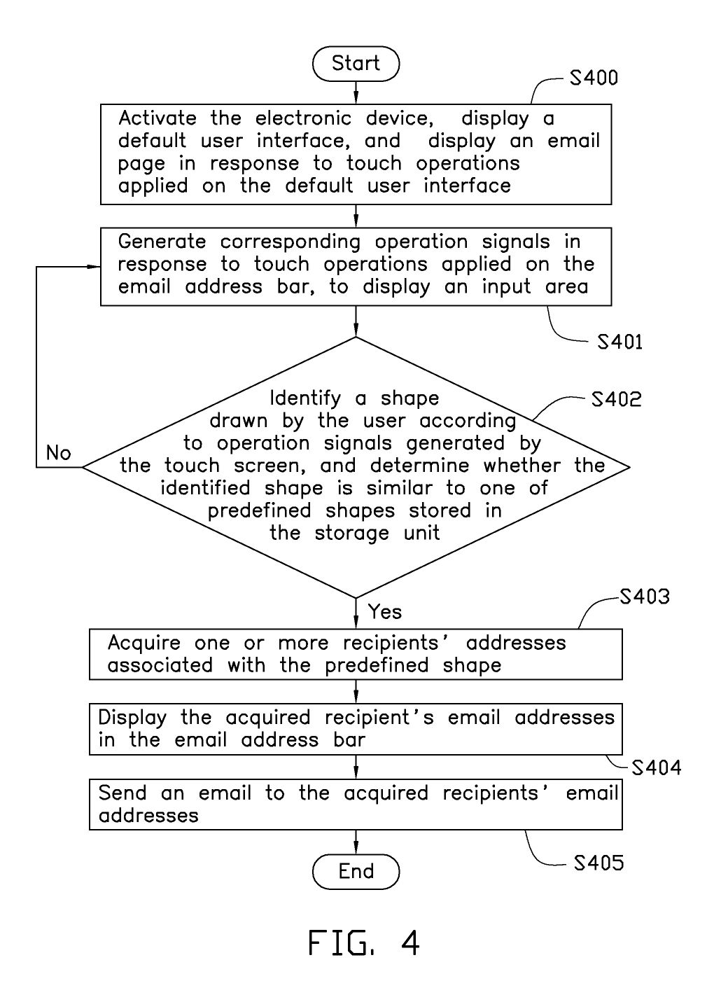

FIG. 4 is a flowchart of a method for quickly sending an email using the electronic device 1. The method comprises the following steps, each of which is related to the various components contained in the electronic device 1.

In step S400, when the electronic device 1 is activated, the display unit 13 displays a default user interface. The electronic device 1 then displays an email page 131 in response to touch operations applied on the default user interface (via the touch screen 111).

In step S401, the touch screen 111 generates corresponding operation signals in response to touch operations applied on the email address bar 1310, to display the input area 1311.

In step S402, the shape identification module 131 identifies a shape drawn by the user according to operation signals generated by the touch screen 111, and determines whether the identified shape is similar to one of the predefined shapes stored in the storage unit 10. If the determination is yes, the process goes to step S403. Otherwise, the process goes back to step S401.

In step S403, the address acquisition module 122 acquires one or more recipients' email addresses associated with the predefined shape.

In step S404, the email address acquisition module 122 controls the display unit 13 to display the acquired recipients' email addresses in the email address bar 1310 of the email page 131. The process returns to step S402 if the user continues to add more email addresses in the email address bar 1310.

In step S405, the email delivery module 123 sends an email to the acquired recipients' email addresses.

Although the present disclosure has been specifically described on the basis of various embodiments thereof, the disclosure is not to be construed as being limited thereto. Various changes or modifications may be made to the embodiments without departing from the scope and spirit of the disclosure.

What is claimed is:

1. A method for quickly sending an email implemented in an electronic device having an input unit and a storage unit, the storage unit having a mapping between a plurality of predefined shapes and a plurality of recipient email addresses recorded therein, the method comprising:
generating corresponding operation signals in response to touch operations performed on the input unit;
identifying a shape of a touch operation according to the generated operation signals;
determining whether the identified shape is similar to one of the predefined shapes;
acquiring one or more recipient addresses associated with the one of the predefined shapes when the identified shape is similar to one of the predefined shapes; and
sending an email to the acquired one or more recipient addresses.

2. The method as described in claim 2, further comprising displaying the acquired one or more recipient email addresses in an email address bar of an email page.

3. The method as described in claim 2, wherein the email page comprises an input area, and the corresponding operation signals are generated in response to touch operations performed on the input unit at the input area.

4. The method as described in claim 3, wherein a default size of the input area is smaller than a size of the email page.

5. The method as described in claim 3, wherein a default size of the input area is the same as a size of the email page.

6. An electronic device, comprising:
a storage unit having a mapping table stored therein, the mapping table having a relationship between a plurality of predefined shapes and a plurality of recipient addresses recorded therein;
an input unit, configured for generating corresponding operation signals in response to touch operations performed thereon;
a shape identification module, configured for identifying a shape of a touch operation according to the generated operation signals, and for determining whether the identified shape is similar to one of the predefined shapes;
an address acquisition module, configured for acquiring one or more recipient addresses associated with the one of the predefined shapes when the identified shape is similar to one of the predefined shapes; and
a delivery module, configured for sending an email to the acquired one or more recipient addresses.

7. The electronic device as described in claim 6, further comprising a display unit, wherein the address acquisition module is configured for controlling the display unit to display the acquired recipient email addresses in an email address bar of the email page.

8. The electronic device as described in claim 7, wherein the email page comprises an input area, and the input unit is configured for generating the corresponding operation signals in response to touch operations performed on the input unit at the input area.

9. The electronic device as described in claim 8, wherein a default size of the input area is smaller than a size of the email page.

10. The electronic device as described in claim 8, wherein a default size of the input area is the same as a size of the email page.

11. The electronic device as described in claim 6, wherein the input unit is selected from the group consisting of a touchpad and a touch screen.
